(19) United States
(12) Patent Application Publication
(10) Pub. No.: US 2023/0067605 A1
(43) Pub. Date: Mar. 2, 2023

(54) DEEP REINFORCEMENT LEARNING-BASED INTELLIGENT JOB BATCHING METHOD AND APPARATUS, AND ELECTRONIC DEVICE

(71) Applicant: Beijing University of Posts and Telecommunications, Beijing (CN)

(72) Inventors: Liang LIU, Beijing (CN); Xiaolong ZHENG, Beijing (CN); Huadong MA, Beijing (CN); Chengling JIANG, Beijing (CN); Zihui LUO, Beijing (CN)

(73) Assignee: Beijing University of Posts and Telecommunications, Beijing (CN)

(21) Appl. No.: 17/456,581

(22) Filed: Nov. 25, 2021

(30) Foreign Application Priority Data
Aug. 23, 2021 (CN) 202110965400.6

(51) Int. Cl. G06N 3/08; G06N 3/04

(52) U.S. Cl. CPC G06N 3/088; G06N 3/0454; G06N 3/0445

(57) ABSTRACT

A deep reinforcement learning (DRL)-based intelligent job batching method and apparatus, and an electronic device are provided. The method includes: obtaining static features and a dynamic feature of each job, where the static features of the job include a delivery date, a specification and a process requirement of the job, and the dynamic feature of the job includes a receiving moment; and inputting the static features and the dynamic feature of each job into a job batching module, and using a Markov decision process (MDP) by the job batching module to combine jobs with similar features in a to-be-batched job set into an identical batch, so as to minimize a total quantity of batches obtained finally and a difference in features of jobs in each batch. The DRL-based intelligent job batching method and apparatus can learn a stable batching strategy and provide a stable and efficient job batching solution.

### CROSS REFERENCE TO THE RELATED APPLICATIONS

This application is based upon and claims priority to Chinese Patent Application No. 202110965400.6, filed on Aug. 23, 2021, the entire contents of which are incorporated herein by reference.

### TECHNICAL FIELD

The present invention relates to the technical field of Industrial Internet of Things (IIoT), and more particularly, to a deep reinforcement learning (DRL)-based intelligent job batching method and apparatus, and an electronic device.

### BACKGROUND

As Industrial Internet of Things (IIoT) grows vigorously, traditional industries are upgrading to intelligent manufacturing. Multi-variety and small-batch flexible production is an important part of intelligent manufacturing. In order to improve device utilization and production efficiency, production enterprises often combine jobs with similar features into a batch and then conduct production in batches. A job batching problem is widespread in chemical, textile, semiconductor, medical, steelmaking, and other fields. For example, in the steelmaking field, each job has a plurality of features, such as a steel number, thickness, width, and weight. Since different customers require different steel products, jobs in the steelmaking field usually have different feature values.

To improve production efficiency, when a capacity constraint of a production device is met, jobs with similar features such as similar steel grades and similar thickness are combined into one batch for production. In actual production, such a job batching process is usually conducted manually. However, manual job batching often has the following problems: (1) A total quantity of to-be-batched jobs is large, a total quantity of batches is unknown, each job has many features, and batching has many constraints such that arrangement and combination for job batching are complicated, and technicians cannot exhaust all feasible solutions in a short period of time. (2) It is difficult for technicians to select an appropriate solution from a large quantity of feasible solutions in a brief period of time.

FIG. 1 shows an ideal smart factory in IIoT. An entire production process can be automated, intelligent, and unmanned through comprehensive perception of production data by intelligent devices, real-time transmission of production data by wireless communication, and rapid calculation of a job batching module in a cloud. Apparently, the quality of the job batching module in the cloud directly affects efficiency of the entire production process. To realize the vision of IIoT, it is desirable to develop an efficient job batching module.

Existing job batch processing research primarily focuses on a clustering algorithm and a metaheuristic algorithm, both of which do not use massive data to learn prior knowledge. The clustering algorithm needs to know in advance the total quantity of batches obtained finally. However, this quantity is unknown in actual application scenarios. The metaheuristic algorithm strongly relies on the experience of technicians, and a result of the meta-heuristic algorithm is unstable and unsuitable for actual production. In addition, as the quantity of jobs increases, the inference duration of the clustering algorithm and metaheuristic algorithm explosively increases. Therefore, it is of great urgency and practical significance to design an efficient and intelligent job batching method for IIoT scenarios.

Reinforcement learning (RL) is an important branch of machine learning, which mainly studies how a job batching module performs actions in an environment to obtain a maximum cumulative reward. Although reinforcement learning training may take more time, once a job batching module is trained, it can quickly perform correct actions for new issues encountered. At present, reinforcement learning has been successfully applied to various scenarios, including control of robots, manufacturing, and games. Deep learning (DL) has a strong perception capability, but lacks a specific decision-making capability, while reinforcement learning has a decision-making capability but lacks a perception capability. Therefore, DRL came into being. In recent years, DRL has successfully resolved various practical problems by combining the decision-making capability of reinforcement learning with the perception capability of deep learning that can process multi-dimensional features. Therefore, the present invention innovatively adopts a DRL-based method to resolve the job batching problem in IIoT.

### SUMMARY

An objective of the present invention is to provide a DRL-based intelligent job batching method and apparatus, and an electronic device. The method can be applied to batching scenarios in which there is a large quantity of jobs in IIoT.

To achieve the foregoing objective, the present invention provides the following technical solutions.

According to a first aspect, the present invention provides a DRL-based intelligent job batching method, including the following steps:

S1: obtaining static features and a dynamic feature of each job, where the static features of the job include a delivery date, a specification and a process requirement of the job, and the dynamic feature of the job includes a receiving moment.

S2: inputting the static features and the dynamic feature of each job into a job batching module, and using a Markov decision process (MDP) by the job batching module to combine jobs with similar features in a to-be-batched job set into an identical batch, so as to minimize a total quantity of batches obtained finally and a difference in features of jobs in each batch.

The MDP is as follows: at each time step, the job batching module obtains a state of a current environment, where a state of a job at a moment t includes static features of the job, a demand for the job at the moment t and a remaining available capacity of a current batch n at the moment t, and a state of the current environment at the moment t is a set of states of all jobs at the moment t; then, a corresponding action is performed based on the state of the current environment, where an effect of the action is measured by a positive or negative reward value, and the reward value is an opposite number of an objective function value; and next, the environment is affected by the action and changes from a current state to a next new state.

Further, a process of performing the action based on the state in step S2 is as follows. A virtual node and other job nodes are used as an input sequence of a model. At each decision moment t, the job batching module sequentially selects one of all nodes in the input sequence as an output node. A first output node of the job batching module is defaulted as the virtual node, which indicates that batching work starts. When the job batching module selects the virtual node as the output node, it indicates that division of the current batch ends. When all jobs are combined into corresponding batches, an output sequence is obtained according to a decision of the job batching module, and the output sequence is a batching result of the job set.

Further, the job batching module in step S2 includes an encoder and a decoder. The encoder uses a one-dimensional convolutional layer as an embedding layer and virtually maps the static features of each job in the input sequence to an output matrix. The decoder mainly includes a long short-term memory (LSTM) network, a pointer network, and a Mask vector. A working process of the decoder is as follows. At each decision moment t, the LSTM network reads a hidden layer state of the LSTM network at a previous decision moment and an output node at the previous decision moment, and outputs a hidden layer state at the moment t. The pointer network calculates a probability of each output node in combination with the Mask vector and based on the output matrix of the encoder, the hidden layer state of the LSTM network at the moment t, a dynamic feature vector of the input sequence at the moment t, and the remaining capacity of the current batch n at the moment t. A length of the Mask vector is equal to a length of the input sequence, and bits of the Mask vector are in one-to-one correspondence to nodes in the input sequence. A value of each bit of the Mask vector is 0 or 1. A value of the bit of the Mask vector corresponding to the virtual node is always 1. Finally, a node with the highest probability is selected as the output node at the moment t. When a decision at the moment t is made, the Mask vector, the dynamic feature vector of the input sequence, and the remaining capacity of the current batch n are immediately updated according to a decision result to be used as an input of the model at a next decision moment.

Further, a working process of the pointer network is as follows: at each decoding time step t, an attention mechanism is used to obtain a weight of the input sequence at the moment t, and the weight is normalized by using a Softmax function to obtain a probability distribution of the input sequence.

Further, the job batching module is trained by using an actor-critic algorithm. The actor-critic algorithm is composed of an actor network and a critic network. The actor network is used to predict a probability of each node in an input sequence at each decision moment and select a node with the highest probability as an output node. The critic network is used to calculate an estimated reward value of the input sequence.

Further, the actor-critic algorithm includes the following steps: randomly initializing a parameter of the actor network and a parameter of the critic network; at each iteration step epoch, randomly selecting J instances from a training set, sequentially determining an output sequence of each instance until all jobs in the instance are combined into corresponding batches, and calculating a reward value of a current output sequence; and after batching for the J instances is completed, calculating and updating a gradient of the actor network and a gradient of the critic network respectively.

According to a second aspect, the present invention provides a DRL-based intelligent job batching apparatus. The apparatus includes:

a feature acquisition module, configured to obtain static features and a dynamic feature of each to-be-batched job, where the static features of the job include a delivery date, a specification and a process requirement of the job, and the dynamic feature of the job includes a receiving moment; and

a job batching module, configured to input the static features and the dynamic feature of each job into the job batching module and use an MDP to combine jobs with similar features in a to-be-batched job set into an identical batch, so as to minimize a total quantity of batches obtained finally and a difference in features of jobs in each batch.

The MDP of the job batching module is as follows: at each time step, the job batching module obtains a state of a current environment, where a state of a job at a moment t includes static features of the job, a demand for the job at the moment t and a remaining available capacity of a current batch n at the moment t, and a state of the current environment at the moment t is a set of states of all jobs at the moment t; then, a corresponding action is performed based on the state of the current environment, where an effect of the action is measured by a positive or negative reward value, and the reward value is an opposite number of an objective function value; and next, the environment is affected by the action and changes from a current state to a next new state.

Further, a process of performing the action is as follows. A virtual node and other job nodes are used as an input sequence of the model. At each decision moment t, the job batching module sequentially selects one of all nodes in the input sequence as an output node. A first output node of the job batching module is defaulted as the virtual node, which indicates that batching work starts. When the job batching module selects the virtual node as the output node, it indicates that division of the current batch ends. When all jobs are combined into corresponding batches, an output sequence is obtained according to a decision of the job batching module, and the output sequence is a batching result of the job set.

Further, the job batching module may include an encoder and a decoder. The encoder uses a one-dimensional convolutional layer as an embedding layer and virtually maps the static features of each job in the input sequence to an output matrix. The decoder mainly includes an LSTM network, a pointer network, and a Mask vector. A working process of the decoder is as follows. At each decision moment t, the LSTM network reads a hidden layer state of the LSTM network at a previous decision moment and an output node at the previous decision moment, and outputs a hidden layer state at the moment t. The pointer network calculates a probability of each output node in combination with the Mask vector and based on the output matrix of the encoder, the hidden layer state of the LSTM network at the moment t, a dynamic feature vector of the input sequence at the moment t, and the remaining capacity of the current batch n at the moment t. A length of the Mask vector is equal to a length of the input sequence, and bits of the Mask vector are in one-to-one correspondence to nodes in the input sequence. A value of each bit of the Mask vector is 0 or 1. A value of the bit of the Mask vector corresponding to the virtual node is always 1. Finally, a node with the highest probability is selected as the output node at the moment t. When a decision at the moment t is made, the Mask vector, the dynamic feature vector of the input sequence, and the remaining capacity of the current batch n are immediately updated according to a decision result to be used as an input of the model at a next decision moment.

Further, a working process of the pointer network is as follows. at each decoding time step t, an attention mechanism is used to obtain a weight of the input sequence at the moment t, and the weight is normalized by using a Softmax function to obtain a probability distribution of the input sequence.

Further, the job batching module is trained by using an actor-critic algorithm. The actor-critic algorithm is composed of an actor network and a critic network. The actor network is used to predict a probability of each node in an input sequence at each decision moment and select a node with the highest probability as an output node. The critic network is used to calculate an estimated reward value of the input sequence.

Further, the actor-critic algorithm includes the following steps: randomly initializing a parameter of the actor network and a parameter of the critic network; at each iteration step epoch, randomly selecting J instances from a training set, sequentially determining an output sequence of each instance until all jobs in the instance are combined into corresponding batches, and calculating a reward value of a current output sequence; and after batching for the J instances is completed, calculating and updating a gradient of the actor network and a gradient of the critic network respectively.

According to a third aspect, the present invention provides an electronic device, including a processor, a communication interface, a memory, and a communication bus. The processor, the communication interface, and the memory communicate with each other through the communication bus.

The memory is configured to store a computer program.

The processor is configured to execute the program stored in the memory to implement any one of the steps of the foregoing DRL-based intelligent job batching method.

According to a fourth aspect, the present invention further provides a computer-readable storage medium. A computer program is stored in the computer-readable storage medium, and the computer program is configured to be executed by a processor to implement any one of the steps of the foregoing DRL-based intelligent job batching method.

According to a fifth aspect, the present invention further provides a computer program product containing an instruction, and the instruction is configured to be run on a computer to cause the computer to perform any one of the steps of the foregoing DRL-based intelligent job batching method.

Compared with the prior art, the present invention has the following advantages:

The DRL-based intelligent job batching method and apparatus, and the electronic device provided in the present invention describe a job batching problem as an MDP and adopt the DRL-based method to resolve the problem. This method can process multi-dimensional input data and does not require labeled data to train the model. In addition, the present invention regards the job batching process as a mapping process from one sequence to another sequence, and proposes the pointer network-based job batching module to minimize the total quantity of job batches and the difference in features of jobs in each batch under the constraint of the batch capacity.

The present invention provides the DRL-based intelligent job batching method and apparatus, and the electronic device to make full use of a large amount of unlabeled data in IIoT to learn a stable batching strategy, process input data with multi-dimensional features, and provide a stable and efficient job batching solution. In particular, even in practical application scenarios in which there is a large quantity of jobs, the method can quickly generate corresponding solutions.

Certainly, implementation of any product or method of the present invention does not necessarily need to achieve all of the foregoing advantages at the same time.

### BRIEF DESCRIPTION OF THE DRAWINGS

In order to describe the technical solutions in embodiments of the present invention or in the prior art more clearly, the following briefly describes the drawings used in the embodiments. Apparently, the drawings in the following description show merely some embodiments of the present invention, and those having ordinary skill in the art may still derive other drawings from these drawings.

FIG. 1 is a schematic diagram of an ideal smart factory in IIoT;

FIG. 2 is a schematic diagram of an input sequence according to an embodiment of the present invention;

FIG. 3 is a schematic diagram of an output sequence according to an embodiment of the present invention;

FIG. 4 is a schematic diagram of an encoder of a job batching module according to an embodiment of the present invention;

FIG. 5 is a schematic diagram of a decoder of the job batching module according to an embodiment of the present invention;

FIG. 6 is a schematic structural diagram of a DRL-based intelligent job batching apparatus according to an embodiment of the present invention; and

FIG. 7 is a schematic structural diagram of an electronic device according to an embodiment of the present invention.

### DETAILED DESCRIPTION OF THE EMBODIMENTS

In order to better understand the technical solutions, a method of the present invention is described in detail below with reference to the drawings. Table 1 describes the meaning of symbols involved in the embodiments of the present invention.

TABLE 1

| Symbol | Meaning |
|---|---|
| X | To-be-batched job set |
| M | Quantity of to-be-batched jobs |
| N | Total quantity of batches (unknown in advance) |
| C | Maximum capacity of a batch |
| K | Quantity of features of a job |
| D | Sum of differences in features of jobs |
| i, j = 1, 2, . . . M | Job number before batching |
| n = 1, 2, . . . N | Batch number |
| k = 1, 2, . . . K | Dimension sequence number of a job feature |
| fᵢ | Feature of an i^{th} job |
| dᵢ | Demand for the i^{th} job |
| cₖ | Importance of a k^{th} feature |
| Uₙ | Job set in an n^{th} batch |
| \|Uₙ\| | Quantity of jobs in the n^{th} batch |
| Vₙ | Remaining available capacity of the n^{th} batch |
| μᵢₙ | Whether the i^{th} job is in the n^{th} batch |

The present invention provides a DRL-based intelligent job batching method, including the following steps:

S1: obtaining static features and a dynamic feature of each job, where the static features of the job include a delivery date, a specification and a process requirement of the job, and the dynamic feature of the job includes a receiving moment.

S2: inputting the static features and the dynamic feature of each job into a job batching module, and using an MDP by the job batching module to combine jobs with similar features in a to-be-batched job set into an identical batch, so as to minimize a total quantity of batches obtained finally and a difference in features of jobs in each batch.

In the present invention, a typical job batching problem that must be faced in IIoT is mainly considered. Specifically, a to-be-batched job set X={Xᵢ,i=1, 2, . . . ,M} is given. Each job Xᵢ may be defined as Xᵢ{fᵢ,dᵢ}, where fᵢ represents features of the job Xᵢ, such as the delivery date, the specification and the process requirement of the job (defined by specific application scenarios) and may be represented by a tuple fᵢ={fᵢₖ,k=1,2, . . . ,K}; and dᵢ represents a demand for the job Xᵢ.

Given that a maximum capacity of a batch is C, a purpose of job batching is to combine jobs with similar features in the to-be-batched job set into an identical batch under the constraint of the batch capacity, so as to minimize the total quantity N of the batches obtained finally and the difference in the features of the jobs in each batch.

A mathematical model of the problem is as follows:

min(αD+βN) (1)

where

$$D = {\sum }_{n = 1}^{N} {\sum }_{i = 1}^{\vert {U}_{n} \vert} {\sum }_{j \neq i}^{\vert {U}_{n} \vert} \sqrt{{{c}_{1} ( {f}_{i 1} - {f}_{j 1} )}^{2} + {{c}_{2} ( {f}_{i 2} - {f}_{j 2} )}^{2} + … + {{c}_{k} ( {f}_{ik} - {f}_{jk} )}^{2}} ; and \qquad ( 1 )$$

$$α + β = 1 \qquad ( 2 )$$

$${\sum }_{k = 1}^{K} {c}_{k} = 1 \qquad ( 3 )$$

$$0 < {\sum }_{i ∈ {U}_{i}} {d}_{i} \leq C \qquad ( 4 )$$

$$0 < {\sum }_{n = 1}^{N} {μ}_{i n} \leq 1 \qquad ( 5 )$$

where

$${μ}_{i n} = \{ \begin{matrix}1 , the {i}^{th} job belongs to the {n}^{th} batch \\ 0 , otherwise\end{matrix} .$$

Formula (1) is an objective function, where D represents the sum of differences in the features of the jobs in all batches. Formula (1) contains two sub-objectives: one is to minimize the total quantity of the batches obtained finally; the other is to minimize the difference in the features of the jobs in each batch (in other words, the jobs with similar features are combined into one batch).

Formula (2) expresses the constraint of importance of the two sub-objectives in formula (1).

Formula (3) expresses the constraint of impact of all attribute features of a job on a job batching result.

Formula (4) expresses that a total quantity of jobs in each batch cannot exceed the maximum capacity of a batch according to a production requirement of an enterprise.

Formula (5) expresses that one job can be combined into only one batch at most.

The MDP is as follows:

The job batching process can be regarded as a process in which the job batching module continuously interacts with an environment by making sequence decisions, and then combines the jobs into a plurality of batches. This process can be represented by the MDP.

Specifically, at each time step, the job batching module obtains a state of a current environment and performs a corresponding action based on the state. An effect of the action is measured by a positive or negative reward value. Then, the environment is affected by the action and changes from a current state to a next new state. The job batching module gradually learns better decisions in such continuous cycles to complete better job batching.

(1) State: in the present invention, it is assumed that when a job Xᵢ is combined into a batch n, a demand for the job changes from dᵢ to 0, that is, the job is successfully allocated into the batch. Simultaneously, a remaining available capacity Vₙ of the current batch n changes from C to C−dᵢ. Therefore, as the current job is combined into a batch, the current demand dᵢ for the job and the remaining available capacity Vₙ of the current batch n are variables related to a moment t.

Therefore, each job Xᵢ may be redefined as Xᵢ={fᵢ,dᵢ^{t}}, where fᵢ and dᵢ^{t} respectively represent the static features and the dynamic feature at the moment t of the job Xᵢ. In a decoding stage (batching stage) of the model, the static features (such as the job delivery date, and the length and width of a product) of the job Xᵢ remain unchanged, while the dynamic feature of the job dynamically changes according to an output stage.

In summary, a state of the job Xᵢ at the moment t can be denoted by a triplet Sᵢ^{t}=(fᵢ,dᵢ^{t},Vₙ^{t}), which respectively represent the static features of the job Xᵢ, demand for the job Xᵢ at the moment t, and the remaining available capacity of the current batch n at the moment t.

In summary, a state of the current environment at the moment t is a set S^{t}={Sᵢ^{t},i=1,2, . . . ,M} of states of all jobs Xᵢ at the moment t.

(2) Action: in order to assist the job batching module to better complete job batching, a virtual node X₀={f₀,d₀} is defined as a batch division node. The virtual node X₀ and the job Xᵢ have identical feature dimensions, except that each feature value f₀ of the virtual node and a demand d₀ for the virtual node are 0 at any time. The virtual node X₀ and other job nodes Xᵢ(i=1,2, . . . ,M) are used as an input sequence of the model. At each decision moment t, the job batching module sequentially selects one of all nodes in the input sequence as an output node. When the job batching module selects the virtual node X₀ as the output node, it indicates that division of the current batch ends. A first output node of the job batching module is defaulted as the virtual node X₀, which indicates that batching work starts. When a termination condition is met (that is, all jobs are combined into corresponding batches), an output sequence is obtained according to a decision of the job batching module, and the output sequence is a batching result of the job set X.

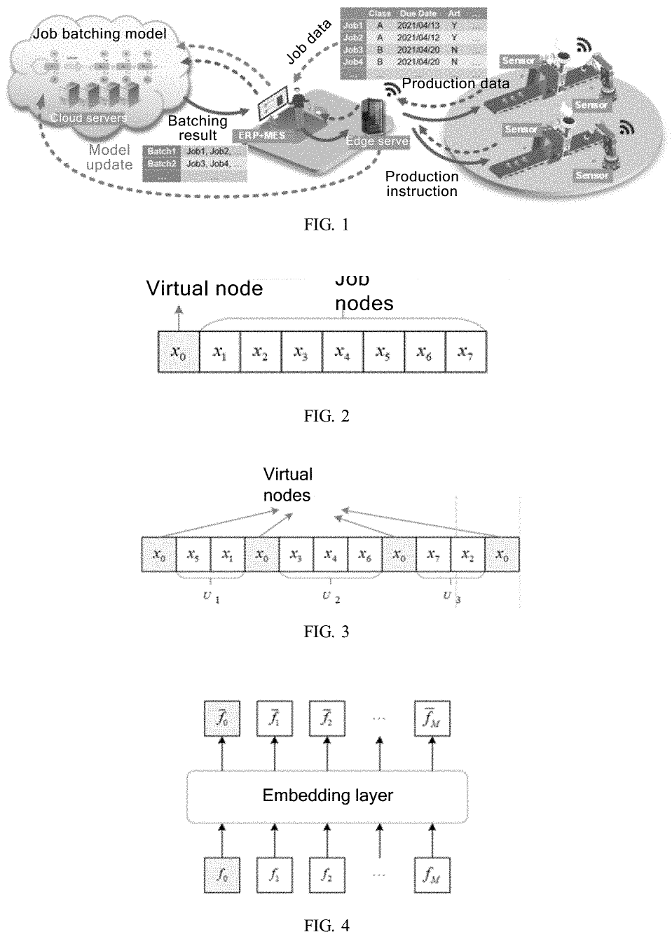

For example (as shown in FIG. 2), for a job set X={Xᵢ,i=1, 2, . . . 7}, a final output sequence (as shown in FIG. 3) of the job batching module is {X₀,X₅,X₁,X₀,X₃,X₄,X₆,X₀,X₅,X₂,X₀}. This result shows that the job batching module divides the job set X into three batches: U₁={X₅,X₁}, U₂={X₃,X₄,X₆}, and U₃={X₇,X₂}.

In summary, the action yₜ performed by the job batching module at the moment t may include two types:

$${y}_{t} = \{ \begin{matrix}Select a job node {X}_{i} ( i = 1 , 2 , … , M ) \\ Select the virtual node {X}_{0}\end{matrix} . \qquad ( 6 )$$

(3) Reward: A reward function intuitively reflects quality of the action performed by the job batching module in the state of the current environment. The objectives of the job batching module are, as expressed by formula (1), to minimize the total quantity of the batches obtained finally and the difference in the features of the jobs in each batch without exceeding the maximum capacity of a batch. A smaller objective function value indicates a larger reward value for the job batching module and further achieve a better batching effect.

Therefore, the reward function is expressed as follows:

R=−(αD+βN) (7)

where D represents the sum of the differences in the features of the jobs as mentioned for formula (1), and N represents the total quantity of batches obtained after batching.

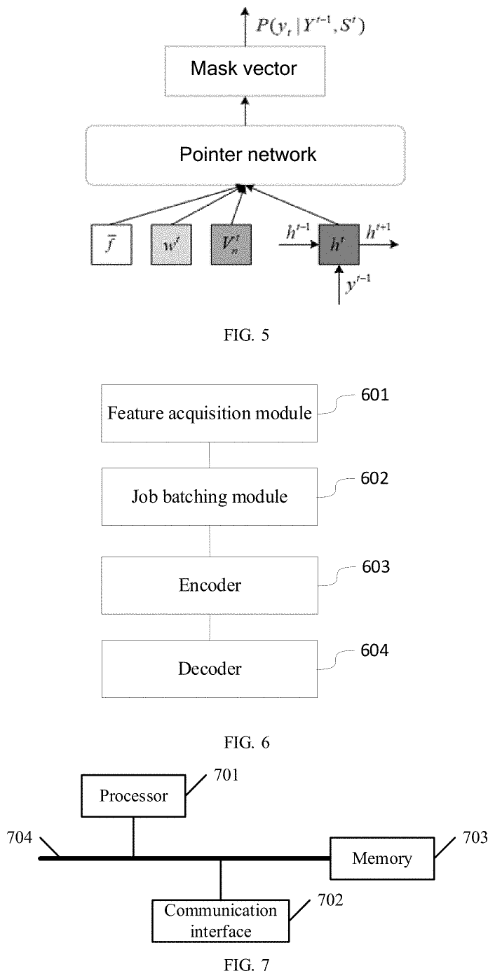

FIG. 4 and FIG. 5 show an overall structure of the job batching module 602 provided in the present invention. The model is implemented based on a pointer network and includes an encoder 603 and a decoder 604.

### (1) Encoder

An encoding layer of the structure of the pointer network is implemented based on a recurrent neural network (RNN). However, the RNN is meaningful only when arrangement in an input sequence conveys specific information (for example, in text translation, an order of a current word and a next word conveys specific related information). Because the input of the model is a set of features of a series of unordered jobs, arrangement in any random input sequence contains the same information as that in the original input. In other words, the order in the input sequence is meaningless.

Therefore, in this model, the RNN in the encoder is omitted, and a one-dimensional convolutional layer is directly used as an embedding layer to map static features fᵢ(i=0,1, . . . ,M) of each job in the input sequence (including virtual nodes and a job set) to a virtual matrix f̅ᵢ(i=0,1, . . . ,M).

### (2) Decoder

The decoder mainly includes an LSTM network, a pointer network, and a Mask vector. A working process of the decoder is as follows. At each decision moment t, the LSTM network reads a hidden layer state h^{t-1} of the LSTM network and an output node y^{t-1} of the job batching module at a previous decision moment, and outputs a hidden layer state h^{t} at the moment t. The pointer network calculates a probability of each output node in combination with the Mask vector and based on the output matrix f̅ᵢ(i=0,1, . . . ,M) of the encoder, the hidden layer state h^{t} of the LSTM network at the moment t, a dynamic feature vector d^{t} of the input sequence at the moment t, and the remaining capacity Vₙ^{t} of a current batch n at the moment t. A length of the Mask vector is equal to a length of the input sequence, and bits of the Mask vector are in one-to-one correspondence to the nodes in the input sequence. A value of each bit of the Mask vector is 0 or 1. A value of the bit of the Mask vector corresponding to the virtual node is always 1. Finally, a node with the highest probability is selected as an output node y^{t} at the moment t. After making a decision at the moment t, the job batching module immediately updates, according to a decision result, the Mask vector, the dynamic feature vector d^{t+1} of the input sequence, the remaining capacity Vₙ^{t+1} of the current batch n and other dynamic variables to be used as an input of the model at a next decision moment.

A mechanism of the pointer network may be as follows: at each decoding time step t, an attention mechanism is used to obtain a weight of the input sequence at the moment t, and the weight is normalized by using a Softmax function to obtain a probability distribution a^{t} of the input sequence. a^{t} is calculated by using the following formula (vₐ and ωₐ are training parameters):

a^{t}=softmax(vₐ tan h(ωₐ[f̅;h^{t};d^{t};Vₙ^{t}])) (8).

To ensure validity of the output sequence of the job batching module, the present invention introduces the Mask vector to add constraints to the decision-making process of the job batching module. The length of the Mask vector is equal to the length of of the input sequence, and the bits of the Mask vector are in one-to-one correspondence to the nodes in the input sequence Xᵢ(i=0,2, . . . ,M). The value of each bit of the Mask vector is 0 or 1. The value of the bit of the Mask vector corresponding to the virtual node X₀ is 1, which indicates that the job batching module can end division of the current batch at any time.

A value of a bit of the Mask vector corresponding to Xᵢ(i=1,2, . . . ,M) is 0 in the following cases:

(a) At the moment t, the job batching module already selects the job Xᵢ as the output node, that is, the job Xᵢ is combined into a batch;

(b) At the moment t, a demand dᵢ for the job Xᵢ is greater than the remaining available capacity Vₙ^{t} of the current batch n;

(c) When t=0, the job batching module can select only the virtual node X₀ as the output node, which indicates that job batching starts.

In combination with the Mask vector, the final probability output by the pointer network at the moment t is calculated by using the following formula (v_{b} is a training parameter):

P(y_{y}|Y^{t-1},S^{t})=softmax(v_{b}a^{t}−ln(Mask)) (9).

It can be learned from formula (9) that when the value of the bit of the Mask vector corresponding to the job Xₜ is 0, the probability that the job Xᵢ is selected as the output node is also 0. At each decoding time step t, formula (9) is calculated, and the node with the highest probability is selected as the output node yₜ at the moment t.

In the present invention, an actor-critic algorithm is used to train the model. The actor-critic algorithm is generally composed of an actor network and a critic network.

The actor network is used to predict the probability of each node in the input sequence at each decision moment t, and select the node with the highest probability as the output node. Assuming a parameter of the actor network is θ, a gradient of the parameter of the actor network is as follows:

$${▽}_{θ} \approx \frac{1}{J} {\sum }_{j = 1}^{J} ( {R}_{j} - V ( {S}_{j}^{0} ; φ ) ) {▽}_{θ} log P ( {Y}_{j} \vert {S}_{j}^{0} ) . \qquad ( 10 )$$

The critic network is used to calculate an estimated reward value of the input sequence. Assuming a parameter of the critic network is φ, a gradient of the parameter of the critic network is as follows:

$${▽}_{φ} \approx \frac{1}{J} {\sum }_{j = 1}^{J} {{▽}_{φ} ( {R}_{j} - V ( {S}_{j}^{0} ; φ ) )}^{2} . \qquad ( 11 )$$

The algorithm specifically includes the following steps:

first randomly initializing the parameter θ of the actor network and the parameter φ of the critic network;

at each iteration step epoch, randomly selecting J instances from a training set (each instance is a set of M jobs), and using a subscript j to represent a jₜₕ instance;

for each instance, sequentially determining the output sequence (namely, performing batching decision) by an improved pointer network according to formula (9) until a termination condition is met (all jobs in this instance are combined into corresponding batches);

at this time, calculating the reward value Rⱼ of a current output sequence of the job batching module according to formula (7); and

after batching for the J instances is completed, calculating and updating the gradient of the actor network and the gradient of the critic network respectively according to formulas (10) and (11).

In formulas (10) and (11), Sⱼ⁹ represents a state of an input sequence of the jₜₕ instance at the moment t=0, Yⱼ represents an output sequence of the final decision of the actor network for Sⱼ⁰, Rⱼ represents an actual reward value of the output sequence of the final decision of the actor network for the jₜₕ instance, P(Yⱼ|Sⱼ⁰) represents a probability of each node in the output sequence of the jₜₕ instance, and V(Sⱼ⁰;φ) represents an estimated reward value of the critic network for Sⱼ⁰ in the jₜₕ instance.

The present invention describes the job batching problem as the MDP and adopts the DRL-based method to resolve the problem. The method can process multi-dimensional input data and does not require labeled data to train the model.

The present invention regards the job batching process as a mapping process from one sequence to another sequence, and proposes the pointer network-based job batching module to minimize the total quantity of job batches and the difference in features of jobs in each batch under the constraint of the batch capacity.

In IIoT scenarios, the job batching problem is widespread, and the quality of the job batching method directly affects efficiency of an entire production process. In view of the job batching problem, the present invention establishes the job batching module based on the pointer network. In addition, the present invention provides the DRL-based intelligent job batching method. The method can make full use of a large amount of unlabeled data in the IIoT to learn a stable batching strategy, process input data with multi-dimensional features, and provide a stable and efficient job batching solution. In particular, even in practical application scenarios in which there is a large quantity of jobs, the method of the present invention can quickly generate corresponding solutions. Therefore, the present invention can be applied to actual production.

Corresponding to the foregoing method embodiment, the present invention further provides a DRL-based intelligent job batching apparatus to implement the foregoing method. Referring to FIG. 6, the apparatus includes the feature acquisition module 601 and the job batching module 602.

The feature acquisition module 601 is configured to obtain static features and a dynamic feature of each to-be-batched job, where the static features of the job include a delivery date, a specification and a process requirement of the job, and the dynamic feature of the job includes a receiving moment.

The job batching module 602 is configured to input the static features and the dynamic feature of each job into the job batching module and use an MDP to combine jobs with similar features in a to-be-batched job set into an identical batch, so as to minimize a total quantity of batches obtained finally and a difference in features of jobs in each batch.

The MDP of the job batching module is as follows. At each time step, the job batching module obtains a state of a current environment, where a state of a job at a moment t includes static features of the job, a demand for the job at the moment t and a remaining available capacity of a current batch n at the moment t, and a state of the current environment at the moment t is a set of states of all jobs at the moment t; then, a corresponding action is performed based on the state of the current environment, where an effect of the action is measured by a positive or negative reward value, and the reward value is an opposite number of an objective function value; and next, the environment is affected by the action and changes from a current state to a next new state.

A process of performing the action is as follows. A virtual node and other job nodes are used as an input sequence of the model. At each decision moment t, the job batching module sequentially selects one of all nodes in the input sequence as an output node. A first output node of the job batching module is defaulted as the virtual node, which indicates that batching work starts. When the job batching module selects the virtual node as the output node, it indicates that division of the current batch ends. When all jobs are combined into corresponding batches, an output sequence is obtained according to a decision of the job batching module, and the output sequence is a batching result of the job set.

The job batching model includes an encoder and a decoder. The encoder uses a one-dimensional convolutional layer as an embedding layer and virtually maps the static features of each job in the input sequence to an output matrix. The decoder mainly includes an LSTM network, a pointer network, and a Mask vector. A working process of the decoder is as follows. At each decision moment t, the LSTM network reads a hidden layer state of the LSTM network at a previous decision moment and an output node at the previous decision moment, and outputs a hidden layer state at the moment t. The pointer network calculates a probability of each output node in combination with the Mask vector and based on the output matrix of the encoder, the hidden layer state of the LSTM network at the moment t, a dynamic feature vector of the input sequence at the moment t, and the remaining capacity of the current batch n at the moment t. A length of the Mask vector is equal to a length of the input sequence, and bits of the Mask vector are in one-to-one correspondence to nodes in the input sequence. A value of each bit of the Mask vector is 0 or 1. A value of the bit of the Mask vector corresponding to the virtual node is always 1. Finally, a node with the highest probability is selected as the output node at the moment t. When a decision at the moment t is made, the Mask vector, the dynamic feature vector of the input sequence, and the remaining capacity of the current batch n are immediately updated according to a decision result to be used as an input of the model at a next decision moment.

A working process of the pointer network is as follows: at each decoding time step t, an attention mechanism is used to obtain a weight of the input sequence at the moment t, and the weight is normalized by using a Softmax function to obtain a probability distribution of the input sequence.

The job batching model is trained by using an actor-critic algorithm. The actor-critic algorithm is composed of an actor network and a critic network. The actor network is used to predict a probability of each node in an input sequence at each decision moment and select the node with the highest probability as an output node. The critic network is used to calculate an estimated reward value of the input sequence.

The actor-critic algorithm includes the following steps: randomly initializing a parameter of the actor network and a parameter of the critic network; at each iteration step epoch, randomly selecting J instances from a training set, sequentially determining an output sequence of each instance until all jobs in the instance are combined into corresponding batches, and calculating a reward value of a current output sequence; and after batching for the J instances is completed, calculating and updating a gradient of the actor network and a gradient of the critic network respectively.

The present invention further provides an electronic device, as shown in FIG. 7, including the processor 701, the communication interface 702, the memory 703, and the communication bus 704. The processor 701, the communication interface 702, and the memory 703 communicate with each other through the communication bus 704.

The memory 703 is configured to store a computer program.

The processor 701 is configured to execute the program stored in the memory 703 to implement the steps of the method in the foregoing method embodiment.

The communication bus in the electronic device may be a peripheral component interconnect (PCI) bus, an extended industry standard architecture (EISA) bus, or the like. The communication bus may be classified as an address bus, a data bus, a control bus, or the like. For ease of representation, only one thick line is used to represent the communication bus in FIG. 7, but this does not mean that there is only one bus or only one type of bus.

The communication interface is used for communication between the foregoing electronic device and other device.

The memory includes a random access memory (RAM), or a non-volatile memory, for example, at least one magnetic disk memory. Optionally, the memory may alternatively be at least one storage apparatus located far away from the foregoing processor.

The processor may be a general-purpose processor, including a central processing unit (CPU), a network processor (NP), or the like; or it may be a digital signal processor (DSP), an application-specific integrated circuit (ASIC), a field-programmable gate array (FPGA) or other programmable logic device, a discrete gate, a transistor logic device, or a discrete hardware component.

The present invention further provides a computer-readable storage medium. A computer program is stored in the computer-readable storage medium, and the computer program is configured to be executed by a processor to implement any one of the steps of the foregoing DRL-based intelligent job batching method.

The present invention further provides a computer program product containing an instruction, and the instruction is configured to be run on a computer to cause the computer to perform any one of the steps of the foregoing DRL-based intelligent job batching method in the foregoing method embodiment.

Some or all of the functions in the foregoing embodiments may be implemented by software, hardware, firmware, or any combination thereof. When software is used to implement the functions, some or all of the functions may be implemented in a form of a computer program product. The computer program product includes one or more computer instructions. When the computer program instructions are loaded and executed on a computer, the procedure or functions according to the embodiments of the present invention are completely or partially generated. The computer may be a general-purpose computer, a special-purpose computer, a computer network, or other programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired manner (such as a coaxial cable, an optical fiber, or a digital subscriber line (DSL)) or a wireless manner (such as infrared, radio, and microwave). The computer-readable storage medium may be any usable medium accessible by a computer, or a data storage device integrated with one or more usable media, such as a server or a data center. The usable medium may be a magnetic medium (such as a floppy disk, a hard disk, or a magnetic tape), an optical medium (such as a digital video disc (DVD), a semiconductor medium (such as a solid state disk (SSD)), or the like.

The foregoing embodiments are used only to describe the technical solutions of the present invention, and are not intended to limit the present invention. Although the present invention is described in detail with reference to the foregoing embodiments, those having ordinary skill in the art should understand that they may still modify the technical solutions described in the foregoing embodiments, or make equivalent substitutions to some technical features therein, while these modifications or substitutions do not make the essence of the corresponding technical solutions depart from the spirit and scope of the technical solutions of the embodiments of the present invention.

What is claimed is:

1. A deep reinforcement learning (DRL)-based intelligent job batching method, comprising the following steps:
S1: obtaining static features and a dynamic feature of each job, wherein the static features of each job comprise a delivery date, a specification and a process requirement of each job, and the dynamic feature of each job comprises a receiving moment; and
S2: inputting the static features and the dynamic feature of each job into a job batching module, and using a Markov decision process (MDP) by the job batching module to combine jobs with similar features in a to-be-batched job set into an identical batch, wherein a total quantity of batches obtained finally and a difference in features of jobs in each batch are minimized;
wherein the MDP is as follows:
at each time step, the job batching module obtains a state of a current environment, wherein a state of a job at a moment t comprises static features of the job, a demand for the job at the moment t and a remaining available capacity of a current batch n at the moment t, and a state of the current environment at the moment t is a set of states of all jobs at the moment t;
a corresponding action is performed based on the state of the current environment, wherein an effect of the action is measured by a positive or negative reward value, and the positive or negative reward value is an opposite number of an objective function value; and
the current environment is affected by the action and changes from a current state to a next new state.

2. The DRL-based intelligent job batching method according to claim 1, wherein a process of performing the corresponding action based on the state in step S2 is as follows:
a virtual node and other job nodes are used as an input sequence of a model;
at each decision moment t, the job batching module sequentially selects one of all nodes in the input sequence as an output node;
a first output node of the job batching module is defaulted as the virtual node, and batching work starts;
when the job batching module selects the virtual node as the output node, division of the current batch ends; and
when all jobs are combined into corresponding batches, an output sequence is obtained according to a decision of the job batching module, and the output sequence is a batching result of the to-be-batched job set.

3. The DLR-based intelligent job batching method according to claim 1, wherein the job batching module in step S2 comprises an encoder and a decoder, wherein
the encoder uses a one-dimensional convolutional layer as an embedding layer and virtually maps the static features of each job in an input sequence to an output matrix; and
the decoder mainly comprises a long short-term memory (LSTM) network, a pointer network, and a Mask vector;
wherein a working process of the decoder is as follows:
at each decision moment t, the LSTM network reads a hidden layer state of the LSTM network at a previous decision moment and an output node at the previous decision moment, and outputs a hidden layer state at the moment t;
the pointer network calculates a probability of each output node in combination with the Mask vector and based on the output matrix of the encoder, the hidden layer state of the LSTM network at the moment t, a dynamic feature vector of the input sequence at the moment t, and the remaining available capacity of the current batch n at the moment t, wherein a length of the Mask vector is equal to a length of the input sequence, bits of the Mask vector are in one-to-one correspondence to nodes in the input sequence, a value of each bit of the Mask vector is 0 or 1, and a value of a bit of the Mask vector corresponding to the virtual node is always 1;
a node with a highest probability is selected as the output node at the moment t; and
when a decision at the moment t is made, the Mask vector, the dynamic feature vector of the input sequence, and the remaining available capacity of the current batch n are immediately updated according to a decision result to be used as an input of the model at a next decision moment.

4. The DRL-based intelligent job batching method according to claim 3, wherein a working process of the pointer network is as follows:
at each decoding time step t, an attention mechanism is used to obtain a weight of the input sequence at the moment t, and the weight is normalized by using a Softmax function to obtain a probability distribution of the input sequence.

5. The DRL-based intelligent job batching method according to claim 1, wherein the job batching module is trained by using an actor-critic algorithm, and the actor-critic algorithm is composed of an actor network and a critic network; wherein
the actor network is used to predict a probability of each node in an input sequence at each decision moment and select a node with a highest probability as an output node; and
the critic network is used to calculate an estimated reward value of the input sequence.

6. The DRL-based intelligent job batching method according to claim 5, wherein the actor-critic algorithm comprises the following steps:
randomly initializing a parameter of the actor network and a parameter of the critic network;
at each iteration step epoch, randomly selecting J instances from a training set, sequentially determining an output sequence of each instance until all jobs in the instance are combined into corresponding batches, and calculating a reward value of a current output sequence; and
after batching for the J instances is completed, calculating and updating a gradient of the actor network and a gradient of the critic network respectively.

7. A deep reinforcement learning (DRL)-based intelligent job batching apparatus, comprising:
a feature acquisition module, configured to obtain static features and a dynamic feature of each to-be-batched job, wherein the static features of each to-be-batched job comprise a delivery date, a specification and a process requirement of each to-be-batched job, and the dynamic feature of each to-be-batched job comprises a receiving moment; and
a job batching module, configured to input the static features and the dynamic feature of each to-be-batched job into the job batching module and use a Markov decision process (MDP) to combine jobs with similar features in a to-be-batched job set into an identical batch, wherein a total quantity of batches obtained finally and a difference in features of jobs in each batch are minimized;
wherein the MDP of the job batching module is as follows:
at each time step, the job batching module obtains a state of a current environment, wherein a state of a job at a moment t comprises static features of the job, a demand for the job at the moment t and a remaining available capacity of a current batch n at the moment t, and a state of the current environment at the moment t is a set of states of all jobs at the moment t;
a corresponding action is performed based on the state of the current environment, wherein an effect of the action is measured by a positive or negative reward value, and the positive or negative reward value is an opposite number of an objective function value; and
the current environment is affected by the action and changes from a current state to a next new state.

8. The DRL-based intelligent job batching apparatus according to claim 7, wherein a process of performing the action is as follows:
a virtual node and other job nodes are used as an input sequence of a model;
at each decision moment t, the job batching module sequentially selects one of all nodes in the input sequence as an output node;
a first output node of the job batching module is defaulted as the virtual node, and batching work starts;
when the job batching module selects the virtual node as the output node, division of the current batch ends; and
when all jobs are combined into corresponding batches, an output sequence is obtained according to a decision of the job batching module, and the output sequence is a batching result of the to-be-batched job set.

9. The DRL-based intelligent job batching apparatus according to claim 8, wherein the job batching module comprises an encoder and a decoder, wherein
the encoder uses a one-dimensional convolutional layer as an embedding layer and virtually maps the static features of each job in the input sequence to an output matrix; and
the decoder mainly comprises a long short-term memory (LSTM) network, a pointer network, and a Mask vector;
wherein a working process of the decoder is as follows:
at each decision moment t, the LSTM network reads a hidden layer state of the LSTM network at a previous decision moment and an output node at the previous decision moment, and outputs a hidden layer state at the moment t;
the pointer network calculates a probability of each output node in combination with the Mask vector and based on the output matrix of the encoder, the hidden layer state of the LSTM network at the moment t, a dynamic feature vector of the input sequence at the moment t, and the remaining available capacity of the current batch n at the moment t, wherein a length of the Mask vector is equal to a length of the input sequence, bits of the Mask vector are in one-to-one correspondence to nodes in the input sequence, a value of each bit of the Mask vector is 0 or 1, and a value of a bit of the Mask vector corresponding to the virtual node is always 1;
a node with a highest probability is selected as the output node at the moment t; and
when a decision at the moment t is made, the Mask vector, the dynamic feature vector of the input sequence, and the remaining available capacity of the current batch n are immediately updated according to a decision result to be used as an input of the model at a next decision moment.

10. An electronic device, comprising a processor, a communication interface, a memory, and a communication bus, wherein
the processor, the communication interface, and the memory communicate with each other through the communication bus;
the memory is configured to store a computer program; and
the processor is configured to execute the program stored in the memory to implement the steps of the DRL-based intelligent job batching method according to claim 1.

11. The electronic device according to claim 10, wherein a process of performing the corresponding action based on the state in step S2 is as follows:
a virtual node and other job nodes are used as an input sequence of a model;
at each decision moment t, the job batching module sequentially selects one of all nodes in the input sequence as an output node;
a first output node of the job batching module is defaulted as the virtual node, and batching work starts;
when the job batching module selects the virtual node as the output node, division of the current batch ends; and
when all jobs are combined into corresponding batches, an output sequence is obtained according to a decision of the job batching module, and the output sequence is a batching result of the to-be-batched job set.

12. The electronic device according to claim 10, wherein the job batching module in step S2 comprises an encoder and a decoder, wherein
the encoder uses a one-dimensional convolutional layer as an embedding layer and virtually maps the static features of each job in an input sequence to an output matrix; and
the decoder mainly comprises a long short-term memory (LSTM) network, a pointer network, and a Mask vector;
wherein a working process of the decoder is as follows:
at each decision moment t, the LSTM network reads a hidden layer state of the LSTM network at a previous decision moment and an output node at the previous decision moment, and outputs a hidden layer state at the moment t;
the pointer network calculates a probability of each output node in combination with the Mask vector and based on the output matrix of the encoder, the hidden layer state of the LSTM network at the moment t, a dynamic feature vector of the input sequence at the moment t, and the remaining available capacity of the current batch n at the moment t, wherein a length of the Mask vector is equal to a length of the input sequence, bits of the Mask vector are in one-to-one correspondence to nodes in the input sequence, a value of each bit of the Mask vector is 0 or 1, and a value of a bit of the Mask vector corresponding to the virtual node is always 1;
a node with a highest probability is selected as the output node at the moment t; and
when a decision at the moment t is made, the Mask vector, the dynamic feature vector of the input sequence, and the remaining available capacity of the current batch n are immediately updated according to a decision result to be used as an input of the model at a next decision moment.

13. The electronic device according to claim 12, wherein a working process of the pointer network is as follows:
at each decoding time step t, an attention mechanism is used to obtain a weight of the input sequence at the moment t, and the weight is normalized by using a Softmax function to obtain a probability distribution of the input sequence.

14. The electronic device according to claim 10, wherein the job batching module is trained by using an actor-critic algorithm, and the actor-critic algorithm is composed of an actor network and a critic network; wherein
the actor network is used to predict a probability of each node in an input sequence at each decision moment and select a node with a highest probability as an output node; and
the critic network is used to calculate an estimated reward value of the input sequence.

15. The electronic device according to claim 14, wherein the actor-critic algorithm comprises the following steps:
randomly initializing a parameter of the actor network and a parameter of the critic network;
at each iteration step epoch, randomly selecting T instances from a training set, sequentially determining an output sequence of each instance until all jobs in the instance are combined into corresponding batches, and calculating a reward value of a current output sequence; and
after batching for the J instances is completed, calculating and updating a gradient of the actor network and a gradient of the critic network respectively.
